(19) United States
(12) Patent Application Publication
(10) Pub. No.: US 2016/0042078 A1
(43) Pub. Date: Feb. 11, 2016

(54) System and Method of Matching Individuals Based on Divorce Rates of Their Country of Origin

(71) Applicant: Jeff Vahey, Mount Dora, NY (US)

(72) Inventor: Jeff Vahey, Mount Dora, NY (US)

(21) Appl. No.: 14/745,578

(22) Filed: Jun. 22, 2015

Related U.S. Application Data
(60) Provisional application No. 62/033,733, filed on Aug. 6, 2014.

(51) Int. Cl. G06F 17/30

(52) U.S. Cl. CPC G06F 17/30867

(57) ABSTRACT

A system and method of matching individuals based upon the divorce rates of their countries of origin. The present invention is an online dating system adapted to allow individuals from countries having a high divorce rate to meet individuals from countries having a lower divorce rate, thereby assisting individuals from the higher divorce rate countries in finding partners that are more likely to produce sustained, long-lasting partnerships. Divorce rates vary greatly from country to country due to a variety of cultural factors, which often makes individuals from a high divorce rate country a poor match for each other in terms of the likelihood that their marriage or relationship will last for an extended period of time because they are subject to the same cultural factors that encourage a high divorce rate.

### CROSS REFERENCE TO RELATED APPLICATIONS

This application claims the benefit of U.S. Provisional Application No. 62/033,733 filed on Aug. 6, 2014. The above identified patent application is herein incorporated by reference in its entirety to provide continuity of disclosure.

### FIELD OF THE INVENTION

The present invention relates to online dating services. More specifically, the present invention relates to online dating services that provide suggested matches for users based the country of origin of the prospective matches.

### BACKGROUND OF THE INVENTION

Online dating sites allow users to search and sort the profiles of other users based upon the character traits that the users desire in a partner. However, individuals are often not cognizant of the types of people who would actually be the best match for them; therefore, they require a dating system having a search function that incorporates expected cultural traits of the prospective partners to match the users with prospective partners with whom the users are more likely to have a long-lasting, sustainable relationship. One such indicator that can be used to predict the likelihood that a relationship will be long-lasting is the divorce rates of the countries of origin for each of the partners. It is a tautology to state that individuals from countries having a high divorce rate are more likely to be divorced; however, it is often overlooked by individuals seeking out permanent partners. Although divorce rate statistics regarding divorce rate cannot be used as a complete proxy for determining the likelihood that two individuals will have a long, successful marriage or partnership, it is an important clue that can be used to assist individuals in finding prospective partners that likely have cultural traits that make them more apt to maintain a long marriage or partnership. Therefore, there is a need in the prior art for a dating system that is adapted to match individuals from high divorce rate countries with individuals from low divorce rate countries in order to provide the individuals from high divorce rate countries with an improved chance of finding a long-lasting and successful relationship.

### SUMMARY OF THE INVENTION

In view of the foregoing disadvantages inherent in the known types of online dating websites, software applications, and systems now present in the prior art, the present invention provides an online dating system configured to match individuals based upon the divorce rates of the countries of which they are nationals, wherein the same can be utilized for providing convenience for the user when seeking a partner with whom the user is more likely to have a sustained relationship. The present invention relates to a client/server web application architecture wherein the client is configured to communicate with a server and access data stored thereon for returning to the client a list of search results based upon search criteria input by a user into the client. At least one of the search criteria sent by the client to the server or database is the nationality of the user profile performing the search via the client. The server or database returns the divorce rate for the country of which the user profile is a national and then returns a list of results of other user profiles stored on the server or database, wherein the returned list of user profiles are nationals of countries having a divorce rate less than the divorce rate of the country of which the user performing the search is a national. The present system thereby provides individuals with the ability to locate prospective partners from countries having a lower average divorce rate than the country of which the user is a national, thereby allowing the user to locate prospective partners with which the user would have an increased likelihood of having a sustained relationship.

### BRIEF DESCRIPTION OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a flowchart of the function of the present invention.

FIG. 2 shows a diagram of an illustrative embodiment of the present invention.

### DETAILED DESCRIPTION OF THE INVENTION

Reference is made herein to the attached drawings. Like reference numerals are used throughout the drawings to depict like or similar elements of the system and method of matching individuals based upon the divorce rates of their country of origin. For the purposes of presenting a brief and clear description of the present invention, the preferred embodiment will be discussed as used for a dating app and/or website. The figures are intended for representative purposes only and should not be considered to be limiting in any respect.

As used herein, “logic” refers to (i) logic implemented as computer instructions and/or data within one or more computer processes and/or (ii) logic implemented in electronic circuitry. As used herein, “computer-readable medium” excludes any transitory signals, but includes any non-transitory data storage circuitry, e.g., buffers, cache, and queues, within transceivers of transitory signals. In the interests of economy, the present disclosure refers to “a computer-readable medium,” “a processor,” “a database,” and so on. However, this should not be read as limiting in any way as the present disclosure contemplates embodiments of the present invention utilizing “one or more computer-readable media,” “one or more processors,” “one or more databases,” and so on. Unless specifically limited to a single unit, “a” is intended to be equivalent to “one or more” throughout the present disclosure.

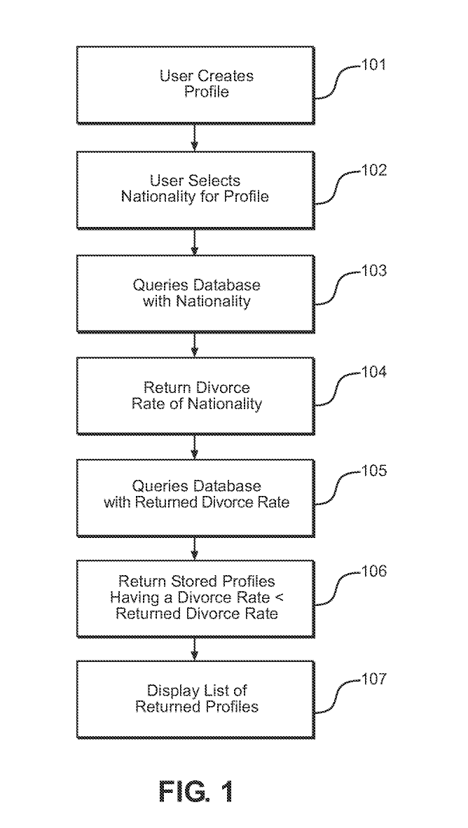

Referring now to FIG. 1, there is shown a flowchart of the function of the present invention. The present invention is a system and method of matching individuals based upon the divorce rates of their countries of origin, thereby allowing individuals from a high divorce rate country to meet prospective partners from a lower divorce rate country to provide the individuals from a high divorce rate country with an improved likelihood of finding a lasting relationship by being matched with individuals who are less likely to seek a divorce due to their cultural background. The present invention comprises a logic stored on a computer-readable medium that, when executed by a processor of an electronic device, causes the device to perform a number of steps, including displaying a GUI to the user for the user to input information into the present system, communicate with a remote server or database via a communications network to perform searches and retrieve other data, and display a list of results and other data to the user via the GUI.

The present system first allows to individuals to create a user profile 101 via a GUI and input information relating to themselves, attaching that information to their user profile. When creating their user profile 101, one of the pieces of information that users are required to enter is their nationality 102. Users' nationality is used by the search function of the present system to provide users with a customized list of results of individuals with whom they are more likely to have a lasting relationship, as compared to potential partners from their own country.

Once the users have created their profile 101 and selected their nationality 102, the users can thereafter conduct searches using the present system to find other individuals with whom they may be interested in dating. Users are able to conduct searches using a variety of search criteria, but a persistent criteria utilized by the present system is the nationality of the user performing the search and the nationalities of the profiles of the other users of the present system stored in a database. When users perform a search, the present system first queries the database with the nationality of the user 103 and the present system returns a divorce rate associated with that nationality 104. The database is configured to store the divorce rates for each country in the world and can be updated as needed to reflect currently available statistical information regarding country-by-country divorce rates.

Once the database has returned the divorce rate 104 for the country of the user, the present system then queries the database with the returned divorce rate 105 and returns a list of stored profiles of other users 106 that are nationals of countries that have a lower divorce rate than the divorce rate of the country of which the user performing the search is a national. Once the list of stored profiles is returned 106, the present system thereafter displays the list of the returned profiles 107 to the user performing the search via the GUI. The present system thereby provides individuals with a means to locate prospective partners from countries having a lower average divorce rate than the divorce rate of the country of which the users are a national, thereby allowing the users from the country having the higher divorce rate to find prospective partners that are less likely to seek a divorce due to the cultural environment in which the prospective partners were raised and are thus more likely to have a sustained relationship with the users performing the search.

The displayed list of returned profiles 107 can be further filtered using a variety of supplemental criteria or traits chosen by the user performing the search, including gender, age, interests, and other such variables. The filtered list of returned results in thereafter displayed to the user via the GUI. Users can access the profiles of the other users via the displayed list of returned profiles 107, allowing individuals to read the other users' profiles and determine whether they would be interested in communicating with the users returned by the search function of the present system.

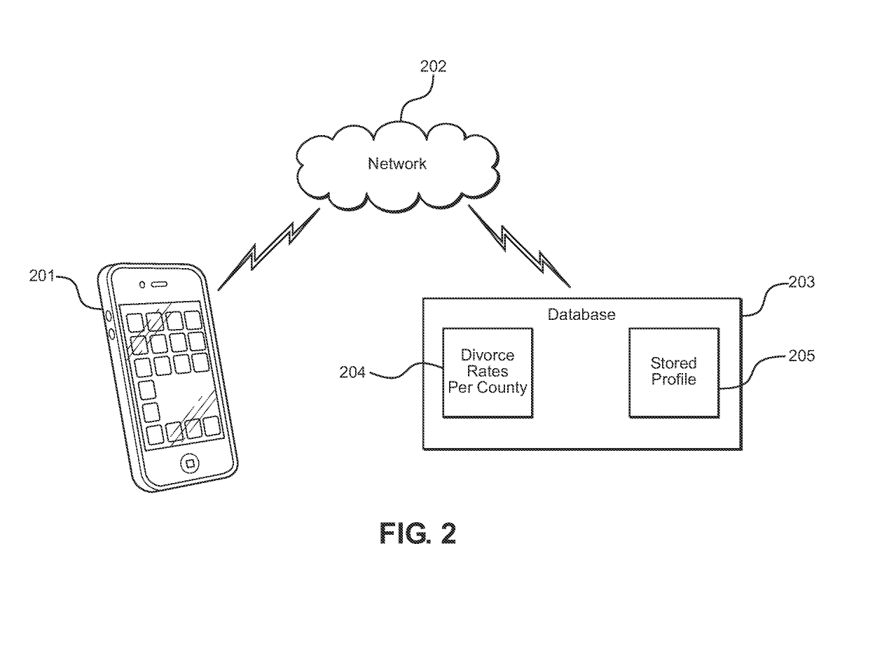

Referring now to FIG. 2, there is shown a diagram of an illustrative embodiment of the present invention. The present system comprises a client 201, such as an electronic device having a web browser of software application, which is adapted to communicate with a server or database 203 via a network 202, such as a hardwired network or a wireless communications network. A user is able to control the functionality of the client with respect to the present system via a GUI embodied in the web browser, software application, or other such program executing the logic of the present system. The server or database 203 stores at least the divorce rates per country 204 and the profiles 205 of the users of the present system.

When a user performs a search using a client 201, the client 201 transmits the search criteria, including the nationality of the user profile performing the search, over the network 202 to the server or database 203. When the search criteria is received thereby, the database 203 first searches the divorce rates per country 204 and returns the divorce rate for the country of which the user profile is a national. The database 203 then searches the stored user profile 205 for stored user profiles 205 that are nationals of countries having a lower divorce rate than the divorce rate of the country of which the searching user profile is a national and returns those results to the client 201 for display thereon. Optionally, the user can search via additional criteria or filter the displayed search results via additional criteria, such as age, sex, interests, and so on.

According to some embodiments, the operations, techniques, and/or components described herein can be implemented as (i) a special-purpose computing device having specialized hardware and a logic hardwired into the computing device to persistently perform the disclosed operations and/or techniques or (ii) a logic that is implementable on an electronic device having a general purpose hardware processor to execute the logic and a computer-readable medium, e.g. a memory, wherein implementation of the logic by the processor on the electronic device provides the electronic device with the function of a special-purpose computing device.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1) A non-transitory computer readable medium that, when executed by a processor of an electronic device, causes the electronic device to perform a method, the method comprising the steps of:
querying a database with a nationality of a user profile, the database comprising one or more stored profiles, a nationality of each of the one or more stored profiles, and a divorce rate corresponding to one or more countries;
returning each of the one or more stored profiles wherein the divorce rate corresponding to the nationality of the one or more stored profiles is less than the divorce rate corresponding to the nationality of the user profile;
displaying the one or more stored profiles returned by the query.

2) The non-transitory computer readable medium of claim 1, wherein the method further comprises the steps of:
querying the database with a supplemental trait;
returning each of the one or more stored profiles wherein the supplemental trait matches a trait of the one or more stored profiles;
displaying the returned one or more stored profiles.

3) The non-transitory computer readable medium of claim 1, wherein the one or more stored profiles returned by the query are displayed via a web browser application.

4) The non-transitory computer readable medium of claim 1, wherein the one or more stored profiles returned by the query are displayed via a software application.

5) A computer system, comprising:
a database comprising one or more stored profiles, a nationality of each of the one or more stored profiles, and a divorce rate corresponding to one or more countries;
a client device comprising a memory, a processor, a logic stored in the memory that, when executed by the processor, causes the client device to perform a method, the method comprising the steps of:
querying the database with a nationality of a user profile;
returning each of the one or more stored profiles wherein the divorce rate corresponding to the nationality of the one or more stored profiles is less than the divorce rate corresponding to the nationality of the user profile;
displaying the one or more stored profiles returned by the query.

6) The computer system of claim 5, wherein the method further comprises the steps of:
querying the database with a supplemental trait;
returning each of the one or more stored profiles wherein the supplemental trait matches a trait of the one or more stored profiles;
displaying the returned one or more stored profiles.

7) The computer system of claim 5, wherein the one or more stored profiles returned by the query are displayed via a web browser application.

8) The non-transitory computer readable medium of claim 5, wherein the one or more stored profiles returned by the query are displayed via a software application.

9) A computer-implemented method, the method comprising the steps of:
querying a database with a nationality of a user profile, the database comprising one or more stored profiles, a nationality of each of the one or more stored profiles, and a divorce rate corresponding to one or more countries;
returning each of the one or more stored profiles wherein the divorce rate corresponding to the nationality of the one or more stored profiles is less than the divorce rate corresponding to the nationality of the user profile;
displaying the returned one or more stored profiles.

10) The computer-implemented method of claim 9, further comprising the steps of:
querying the database with a supplemental trait;
returning each of the one or more stored profiles wherein the supplemental trait matches a trait of the one or more stored profiles;
displaying the one or more stored profiles returned by the query.

11) The computer-implemented method of claim 9, wherein the one or more stored profiles returned by the query are displayed via a web browser application.

12) The computer-implemented method of claim 9, wherein the one or more stored profiles returned by the query are displayed via a software application.
